(19) United States
(12) Patent Application Publication
(10) Pub. No.: US 2019/0130318 A1
(43) Pub. Date: May 2, 2019

(54) CHARGE MANAGEMENT SERVER AND METHOD OF CONTROLLING THE SAME

(71) Applicants: Hyundai Motor Company, Seoul (KR); Kia Motors Corporation, Seoul (KR)

(72) Inventors: Ji A Lee, Uiwang (KR); Ji Min Han, Anyang (KR); Jung Mi Park, Anyang (KR)

(21) Appl. No.: 16/171,656

(22) Filed: Oct. 26, 2018

(30) Foreign Application Priority Data
Oct. 27, 2017 (KR) 10-2017-0141101

(51) Int. Cl. G06Q 10/02; G06Q 50/30; G07B 15/06; B60L 11/18

(52) U.S. Cl. CPC G06Q 10/02; G06Q 50/30; B60L 11/185; B60L 11/1846; G07B 15/063

(57) ABSTRACT

A charge management server and a method of controlling the same are provided. The method includes receiving a reservation time and reference usage fees of a first charger that is disposed in a first charging station from a first charging station server. The reservation time and real-time usage fees are transmitted to a first vehicle that generates a request for charging station information. In response to receiving a charging reservation request with respect to the first charger from the first vehicle, the reservation information is transmitted to the first vehicle. The real-time usage fees are determined as the sum of the reference usage fees and variable usage fees.

### CROSS REFERENCE TO RELATED APPLICATION(S)

This application claims the benefit of Korean Patent Application No. 10-2017-0141101, filed on Oct. 27, 2017, which is hereby incorporated by reference as if fully set forth herein.

### BACKGROUND

### Field of the Invention

The present invention relates to a charge management server, and more particularly, to a charge management server and a method of controlling the same, for managing a charging station for an electric vehicle.

### Discussion of the Related Art

Recently, demand for eco-friendly vehicles has increased in the automotive market. An eco-friendly vehicle, i.e., an electric vehicle (EV) or a plug-in hybrid electric vehicle (PHEV) (hereinafter referred to as an electric vehicle) requires a charging device to charge a high-voltage battery.

The charging device is classified into an on-board-charger (OBC) and a high-speed charger. The OBC is standardized to be compatible with all vehicle types and uses a method of supplying general commercially available alternating current (AC) power (e.g., 220 V) to a vehicle to charge the vehicle. The OBC is a device that receives electric energy (e.g., AC power) from electric vehicle supply equipment (EVSE) and charges a high-voltage battery through an in-cable control box (ICCB). Charging time may be about 4 to 6 hours depending on battery capacity. The high-speed charger for charging using an external power supply uses a method of supplying direct current (DC) of about 100 to 450 V to an electric vehicle to charge a battery and low charging time (e.g., about 30 minutes to 40 minutes) may be consumed due to high-voltage and high-capacity charging. An OBC or a high-speed charger may be disposed in a charging station. Recently, since demand for electric vehicles has increased, it is important to expand supply of charging infrastructure such as charging stations and to manage charging infrastructures.

In particular, compared with fuel supply time of a fossil fuel vehicle using diesel, gasoline, or the like, an electric vehicle has a substantially long charging time of a battery. In general, refueling time at a gas station requires about 10 minutes but charging time of an electric vehicle requires at least 30 to 40 minutes and at most 4 to 6 hours. In addition, charging time is increased when another electric vehicle is being charged and, thus, standby time may be increased. Charging time or standby time is long and, thus, drivers of an electric vehicle are able to make a reservation with a charging station. However, when drivers reserve a charging station, they experience inconvenience. In addition, the reservation is mainly concentrated into a specific time zone (e.g., rush hour) and, thus, a driver is inconvenienced in making a reservation.

Accordingly, there is a need for a charging station management method including a reservation method for distributing reservation time of the charging station to reduce standby time for use of the charging station.

### SUMMARY

An object of the present invention is to provide a charge management server and a method of controlling the same. Another object of the present invention is to provide a method of controlling a charge management server, for providing reservation state information of a charging station to an electric vehicle using telematics technology. In particular, the present invention provides a method of controlling a charge management server for distributing standby time for charging an electric vehicle by changing usage fees based on supply and demand, e.g., by imposing relatively high usage fees when the number of charging reservations is greater than a particular number.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of controlling a charge management server may include receiving a reservation time and a reference usage fees of a first charger disposed in a first charging station from a first charging station server, transmitting the reservation time and real-time usage fees to a first vehicle that creates a request for charging station information, and upon receiving a charging reservation request with respect to the first charger from the first vehicle, transmitting reservation information to the first vehicle, wherein the real-time usage fees are determined as the sum of the reference usage fees and variable usage fees.

The method may further include, upon receiving a payment request from the first vehicle, matching cost including the real-time usage fees with the first vehicle. The variable usage fees may be determined based on a number of charging reservation requests with respect to chargers disposed in the first charging station from at least one other vehicle except for the first vehicle for a predetermined time period.

In addition, when reservation request time included in the charging reservation request is in a predetermined time zone, a predetermined ratio may be applied to determine the variable usage fees. The variable usage fees may be determined according to a charging method included in the charging reservation request and the charging method may include low-speed charging and high-speed charging.

The variable usage fees may be determined based on a charging degree included in the charging reservation request and the charging degree may include complete charging and partial charging. When the reservation request time included in the charging reservation request is in a time period between reservation charging time in a charging reservation request of a second vehicle with respect to the first charger and reservation charging time in a charging reservation request of a third vehicle with respect to the first charger, a predetermined ratio may be applied to determine the variable usage fees.

In particular, the predetermined ratio applied to the variable usage fees may be less than 1. When the reservation request time included in the charging reservation request is in a time period between reservation charging time in a charging reservation request of a second vehicle with respect to the first charger and reservation charging time in a charging reservation request of a third vehicle with respect to the first charger, the variable usage fees may be determined as a negative value.

The transmitting of the reservation information may include transmitting the reservation information to a second vehicle currently performing charging through the first charger at a time point when a charging reservation request with respect to the first charger is received from the first vehicle. In some exemplary embodiments, the method may further include transmitting a charging station list that includes at least one charging station positioned within a predetermined distance from the first vehicle, to the first vehicle.

The transmitting of the charging station list to the first vehicle may include generating the charging station list in which charging stations are aligned in a priority order from a shortest distance to the at least one charging station from the first vehicle. The variable usage fees may be determined by applying a predetermined ratio in consideration of a time period between start time of reservation request time included in the charging reservation request and a time point of receiving the charging reservation request.

In addition, variable usage fees when the time period between the start time and the time point of receiving the charging reservation request is greater than a particular time period may be determined to be less than variable usage fees when the time period between the start time and the time point of receiving the charging reservation request is less than the particular time period. In some exemplary embodiments, the method may further include matching a final cost determined as the sum of the cost and penalty with the first vehicle. The penalty may be determined based on a non-retrieval time to vehicle retrieval from charge termination. The transmitting of the reservation time and the real-time usage fees to the first vehicle may include determining whether the first charging station is positioned within a predetermined distance from the first vehicle or whether the first charging station is positioned within a driving available distance of the first vehicle.

In another aspect of the present invention, a non-transitory computer readable recording medium with a program recorded thereon may be provided for executing the method. In another aspect of the present invention, a charge management server may include a communication unit configured to receive reservation time and reference usage fees of a first charger disposed in a first charging station from a first charging station server and receive a charging station information request from a first vehicle. Additionally, the server may include a controller configured to calculate real-time usage fees determined as the sum of the reference usage fees and variable usage fees. The communication unit may be configured to transmit the reservation time and real-time usage fees to a first vehicle generating a request for charging station information and, upon receiving a charging reservation request with respect to the first charger from the first vehicle, the communication unit may be configured to transmit reservation information to the first vehicle.

In response to receiving a payment request from the first vehicle, the controller may be configured to match cost including the real-time usage fees with the first vehicle. The controller may further be configured to determine the variable usage fees based on a number of charging reservation requests with respect to chargers disposed in the first charging station from at least one other vehicle except for the first vehicle for a predetermined time period.

When a reservation request time included in the charging reservation request is in a predetermined time zone, the controller may be configured to apply a predetermined ratio to determine the variable usage fees. In addition, the controller may be configured to determine the variable usage fees according to a charging method included in the charging reservation request and the charging method may include low-speed charging and high-speed charging.

In particular, the controller may be configured to determine the variable usage fees based on a charging degree included in the charging reservation request and the charging degree may include complete charging and partial charging. When the reservation request time included in the charging reservation request is in a time period between reservation charging time in a charging reservation request of a second vehicle with respect to the first charger and reservation charging time in a charging reservation request of a third vehicle with respect to the first charger, the controller may be configured to apply a predetermined ratio to determine the variable usage fees.

The predetermined ratio applied to the variable usage fees may be less than 1. When the reservation request time included in the charging reservation request is in a time period between reservation charging time in a charging reservation request of a second vehicle with respect to the first charger and reservation charging time in a charging reservation request of a third vehicle with respect to the first charger, the controller may be configured to determine the variable usage fees as a negative value.

In addition, the communication unit may be configured to transmit the reservation information to a second vehicle currently performing charging through the first charger at a time point when a charging reservation request with respect to the first charger is received from the first vehicle. The communication unit may also be configured to transmit a charging station list including at least one charging station positioned within a predetermined distance from the first vehicle, to the first vehicle.

The controller may be configured to generate the charging station list in which charging stations are aligned in a priority order from a shortest distance to the at least one charging station from the first vehicle. The controller may then be configured to determine the variable usage fees by applying a predetermined ratio in consideration of a time period between start time of reservation request time included in the charging reservation request and a time point of receiving the charging reservation request.

In some exemplary embodiments, variable usage fees when the time period between the start time and the time point of receiving the charging reservation request is greater than a particular time period may be determined to be less than variable usage fees when the time period between the start time and the time point of receiving the charging reservation request is less than the particular time period. The controller may be configured to match a final cost determined as the sum of the cost and penalty with the first vehicle, and the penalty may be determined based on a non-retrieval time to vehicle retrieval from charge termination. Further, the controller may be configured to determine whether the first charging station is positioned within a predetermined distance from the first vehicle or whether the first charging station is positioned within a driving available distance of the first vehicle.

In another aspect of the present invention, a vehicle may include a communication unit configured to generate a request for charging station information to a charge management server and to receive reservation time and real-time usage fees with respect to each of a plurality of chargers disposed in the charging station, from the charge management server. Additionally, the vehicle may include a display configured to output the reservation time and the real-time usage fees with respect to each of the plurality of chargers; and an input unit configured to input a reservation request for a first charger among the plurality of chargers. The real-time usage fees may be determined as the sum of the reference usage fees and variable usage fees by the charge management server.

In addition, the input unit may include a user interface configured to receive information through a timetable that includes the reservation time and the real-time usage fees for each of the plurality of chargers displayed on the display. The timetable may include a bar configured to scroll in right and left directions to monitor reservations of other time zones, outputs a highlight on a specific reservation time, and outputs a highlight on reservation available time based on estimated time of arrival to the charging station.

### BRIEF DESCRIPTION OF THE DRAWINGS

The accompanying drawings, which are included to provide a further understanding of the invention and are incorporated in and constitute a part of this application, illustrate exemplary embodiment(s) of the invention and together with the description serve to explain the principle of the invention. In the drawings:

FIG. 1 is a structural diagram illustrating a method of controlling a charge management server according to an exemplary embodiment of the present invention;

FIG. 2 is a structural diagram illustrating a charge management server for managing a charging station server according to an exemplary embodiment of the present invention;

FIG. 3 is a flowchart illustrating a method of controlling a charge management server according to an exemplary embodiment of the present invention;

FIG. 4 shows reservation information in the form of a time table output from a vehicle according to an exemplary embodiment of the present invention; and

FIG. 5 shows reservation information in the form of a list output from a vehicle according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Reference will now be made in detail to the exemplary embodiments of the present invention, examples of which are illustrated in the accompanying drawings. The suffixes “module” and “unit” of elements herein are used for convenience of description and thus can be used interchangeably and do not have any distinguishable meanings or functions.

Although all elements constituting the exemplary embodiments of the present invention are described as integrated into a single one or to be operated as a single one, the present invention is not necessarily limited to such exemplary embodiments. According to exemplary embodiments, all of the elements may be selectively integrated into one or more and be operated as one or more within the object and the scope of the present invention. Each of the elements may be implemented as independent hardware. Alternatively, some or all of the elements may be selectively combined into a computer program having a program module performing some or all functions combined in one or more pieces of hardware. A plurality of code and code segments constituting the computer program may be easily understood by those skilled in the art to which the present invention pertains. The computer program may be stored in non-transitory computer readable media such that the computer program is read and executed by a computer to implement embodiments of the present invention. Computer program storage media may include magnetic recording media, optical recording media, and carrier wave media.

In description of exemplary embodiments, it will be understood that, when an element is referred to as being “on” or “under” and “before” or “after” another element, the element can be directly on another element or intervening elements may be present. All terms including technical or scientific terms have the same meanings as generally understood by a person having ordinary skill in the art to which the present invention pertains unless mentioned otherwise. Generally used terms, such as terms defined in a dictionary, should be interpreted to coincide with meanings of the related art from the context. Unless differently defined in the present invention, such terms should not be interpreted in an ideal or excessively formal manner.

It will be understood that, although the terms first, second, A, B, (a), (b), etc. may be used herein to describe various elements of the present invention, these terms are only used to distinguish one element from another element and essential, order, or sequence of corresponding elements are not limited by these terms. It will be understood that when one element is referred to as being “connected to”, “coupled to”, or “access” another element, one element may be “connected to”, “coupled to”, or “access” another element via a further element although one element may be directly connected to or directly access another element.

In the following description of the at least one exemplary embodiment, a detailed description of known functions and configurations incorporated herein will be omitted for the purpose of clarity and for brevity. Recently, vehicles with telematics, which is wireless communication technology for vehicles, have been extensively used. Telematics is a necessary factor for a function such as autonomous driving and safety using wireless communication technology and sensors mounted in a vehicle. Telematics is mainly applied to a device for generating warning of vehicle security or states or warning sound for warning of a distance and crash with an external signal lamp system and an obstruction. In addition, telematics may also include technology for controlling a vehicle state based on a communication network, such as remote observation and vehicle tracking.

Telematics may transmit information required by a vehicle in conjunction with an audio video navigation (AVN) device and the AVN device may output the received information through a display to provide the information to a driver. A charge management server according to the present invention may be configured to transmit and receive information regarding charging to and from a vehicle via telematics and provide the information regarding charging to a driver to distribute reservation time of a charging station.

FIG. 1 is a structural diagram for explanation of a method of controlling a charge management server according to an exemplary embodiment of the present invention. Referring to FIG. 1, a telematics module 110 installed in a vehicle may be connected to a telematics server 130 using wireless communication technology and may be connected to a user terminal 120 using wireless communication technology or local-area communication technology. The charge management server according to the present invention may include the telematics server 130.

The telematics server 130 may be a network device managed to support telematics technology installed within a vehicle and may store unique vehicle information, vehicle driving information, and the like. The telematics server 130 may be operatively connected to the vehicle via a wireless communication network during vehicle driving or before/after vehicle driving. The telematics server 130 may be configured to store information set by a driver (user) and facilitate manipulation of a device/function related to vehicle driving and safety.

The user terminal 120 may be, for example, a smartphone carried by a driver (user). The user terminal 120 may be operatively connected to the vehicle or the telematics server 130 via wireless communication technology and local-area communication technology and may be configured to store or acquire vehicle unique information, driver personal information, or the like. The telematics server 130 included in the charge management server may be configured to provide information related to reservation to the telematics module 110 or the user terminal 120 of a driver requesting a reservation with a charging station.

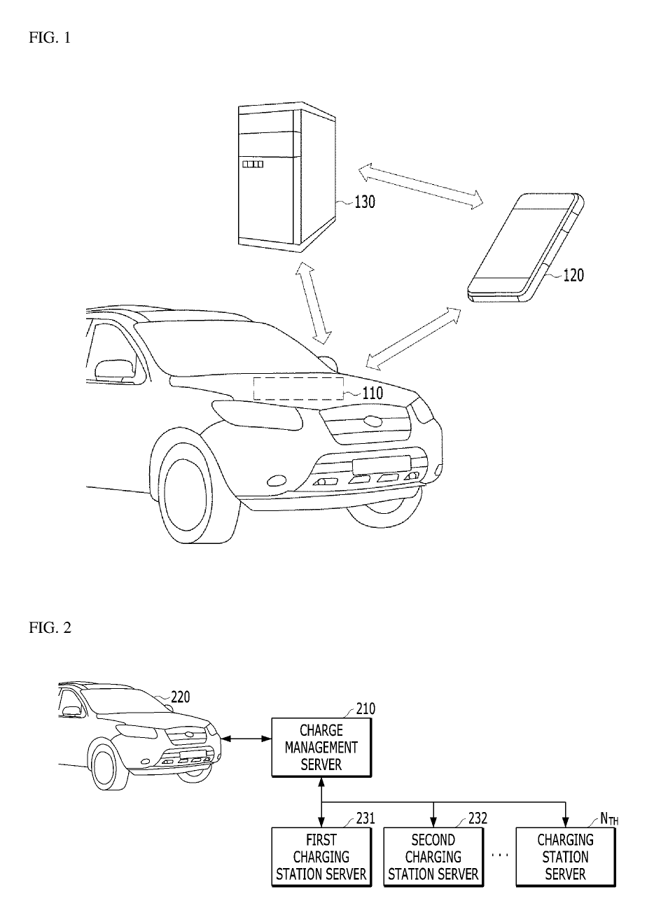

FIG. 2 is a structural diagram for explanation of a charge management server for managing a charging station server according to an exemplary embodiment of the present invention. Referring to FIG. 2, the charge management server may be configured to receive information indicating charge reservation situations from charging station servers, respectively.

For example, the charge management server may be configured to receive information regarding a reservation time and usage fees that are set in a first charger disposed in a first charging station, from a first charging station server. For example, the reservation time set in the first charger may be set to a value from 09:00 to 09:10 and the usage fees may be set to about 200 won/kWh. The charge management server and each charging station server may be configured to transmit and receive information regarding the reservation time and usage fees to and from each other by wire or wirelessly.

The charge management server may be configured to receive information regarding a penalty set in the first charger. The penalty may be defined as an amount of money to be paid based on a time period (hereinafter referred to as “non-retrieval time”) to vehicle retrieval from charge termination when a driver does not retrieve the vehicle within a predetermined time period after the first charger terminates charging. For example, the penalty may be set to about 100 won/minute. However, the penalty may be differently set for each time zone. Additionally, the charging station may include at least one charger disposed therein and a first charging station may include a plurality of chargers using different charging methods. For example, the first charger disposed in the first charging station may be an on-board-charger (OBC) and the second charger may be a high-speed charger.

The first charging station server may be configured to monitor whether reservation is set in each charger disposed in a first charging station or whether charging is currently performed at that charger. As a monitoring result, when reservation is set in the first charger or charging is currently performed at the first charger, the first charging station server may be configured to transmit information regarding usage time, reservation time, or usage fees that vary based on the reservation time. For example, the usage fees of the charging station, which are set at rush hour, may be higher than usage fees at lunch time (e.g., midday).

The first charging station server may be configured to detect whether reservation is set in each charger every first time period or whether charging is currently performed and transmit the result to the charge management server every second time period. In response to detecting that reservation is set in the first charger or the first charger is currently being used, the first charging station server may be configured to immediately transmit the result to the charge management server. The charge management server may then be configured to calculate a reservation available time or an available time of another vehicle using reservation time or a charging time set in the first station disposed in the first charging station from the first charging station server.

A first vehicle may be configured to transmit an information request for charging to the charge management server. Additionally, the first vehicle may be configured to monitor the remaining power of a battery mounted within the first vehicle and, when the current remaining power is equal to or less than a predetermined amount, an alarm indicating that charging is required may be output to the driver. The first vehicle may be configured to calculate a driving available distance (e.g., a distance to empty) by which the vehicle is capable of being driven using the current remaining power and transmit the calculation result to the driver along with the alarm.

Accordingly, the driver may search for a charging station using a user interface of an input device mounted within the first vehicle and the first vehicle may be configured to transmit an information request regarding a charging station positioned within a predetermined distance to the charge management server via a telematics module. The first vehicle may also be configured to transmit a current position information thereof, and the request information including the driving available distance to the charge management server.

In response thereto, the charge management server may be configured to conduct a search for a charging station positioned within a predetermined distance or a charging station positioned within the driving available distance using the current position information of the first vehicle. The charge management server may then be configured to provide the search result to the first vehicle. For example, the first charging station may be positioned within a predetermined distance (e.g., about 7 km) from the first vehicle and the charge management server may be configured to add the position information of the first charging station, information regarding a distance between the first vehicle and the first charging station, and reservation information of a first charger disposed in the first charging station in the search result and transmit the search result including the information to the first vehicle.

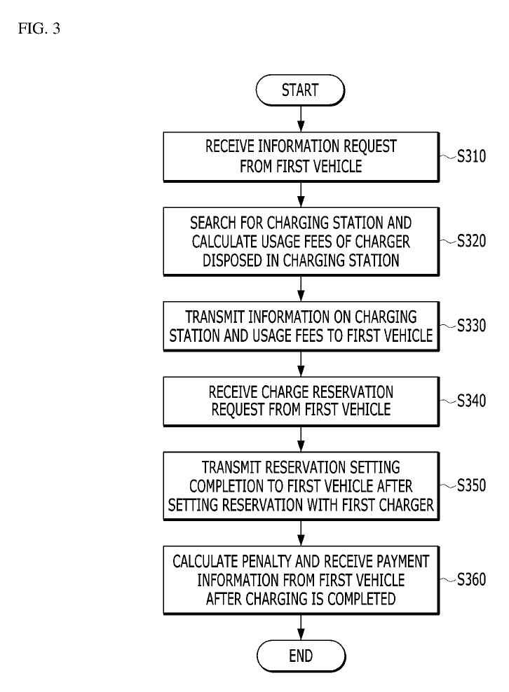

The reservation information may include at least one of a reservation time of another vehicle set in the first charger, and usage fees and penalty set in the reservation time. The charge management server may also be configured to calculate usage fees changed based on the reservation time. A method of calculating usage fees is described in detail with reference to FIG. 3. The first vehicle that receives the search result may then be configured to transmit a charging reservation request including reservation setting information with respect to the first charger to the charge management server and the charge management server may, in response, be configured to set reservation with the first charger through the first charging station server.

Further, when reservation setting is completed, the charge management server may be configured to transmit information regarding a reservation setting completion including information regarding the reservation, to the first vehicle or a portable terminal of the driver, matched with the first vehicle. Additionally, the charge management server 210 may be configured to transmit the reservation information to the second vehicle that is currently charging at the first charger at a time point when the charging reservation request of the first charger is received from the first vehicle. In particular, a user, currently using the first charger, performs charging exceeding the predetermined reservation time. Therefore, when there is a charging reservation request of another vehicle (e.g., a second vehicle) with respect to the first charger, the charge management server may be configured to provide a notification to the second vehicle regarding the charging reservation request to indicate that additional use by the second vehicle is not allowed.

Further, the charge management server 210 may be configured to transmit a charging station list to the first vehicle that includes at least one charging station positioned in the predetermined distance from the first vehicle. The charge management server 210 may be configured to generate the charging station list in which charging stations are aligned in a priority order from a shortest distance to at least one charging station from the first vehicle (e.g., based on distance from the vehicle to the charging station) and transmit the generated charging station list to the first vehicle.

Even when there is no information request with respect to the charging station from the first vehicle, the charge management server 210 may be configured to transmit the charging station list when a distance between the first vehicle and the charging station is less than a predetermined distance. The charge management server 210 may also be configured to generate the charging station list in a specific priority order and, in some exemplary embodiments, the priority order may preferentially take a shortest distance between the charging station and the first vehicle. In other words, the charge management server 210 may be configured to transmit the charging station list to the first vehicle including charging stations aligned in the priority order among at least one charging station within the predetermined distance from the first vehicle. The predetermined distance may be set by the deriver.

In some exemplary embodiments, the priority order may preferentially take the shortest distance between the charging station and the first vehicle among at least one charging station positioned in the driving available distance in consideration of the driving available distance of the first vehicle. In addition, the priority order may preferentially take the shortest distance between the charging station and the first vehicle among at least one charging station positioned within a distance by which the first vehicle travels for estimated time of arrival at a destination.

Alternately, the priority order may preferentially take the lowest real-time usage fees among at least one charging station positioned within a predetermined distance of the first vehicle. The priority order may be set based on a charging pattern of a driver and, for example, when a number of times that the driver performs charging at a specific charging station is equal to or greater than a predetermined value, the specific charging station may be preferentially selected. In other words, the priority order may be based on the frequency at which the vehicle is charged at different charging stations.

The charging pattern may be determined to preferentially take high-speed charging when a number of times of low-speed charging is equal to or greater than high-speed charging by a predetermined value according to a charging method. In addition, the charging pattern may be determined to preferentially select a charging station in which complete charging is possible when a number of times that complete charging is performed are equal to or greater than a number of times that partial charging is performed by a predetermined value. The priority order may be considered using a single factor or multiple factors.

FIG. 3 is a flowchart illustrating a method of controlling a charge management server according to an exemplary embodiment of the present invention. Referring to FIG. 3, the charge management server may be configured to receive an information request related to a charging station for performing charging, from the first vehicle. The information request received from the first vehicle may include current position information of the first vehicle, information regarding driving available distance (or current remaining power of a battery) of the first vehicle, information regarding a driving path of the first vehicle, and time required for complete charging.

The charge management server may then be configured to search for a charging station positioned within a predetermined distance from the first vehicle using the current position information of the first vehicle. In particular, the charge management server may be configured to search for a charging station positioned on the driving path of the first vehicle or search for a charging station positioned within the driving available distance of the first vehicle. The charge management server may also be configured to apply estimated time of arrival from the current position of the first vehicle to search for an available charging station and charger. For example, even when the first charger is currently being used, when charging is completed within the estimated time of arrival, the charge management server may include information regarding the first charging station to an available charging station list. In other words, the charging at the first charger would be complete when the vehicle reaches the charger and thus that particular charger may be included in the list.

The charge management server may then be configured to calculate a reservation available time based on reservation time of another vehicle (e.g., a second vehicle), set in the first charger disposed in the retrieved first charging station and calculate usage fees of the reservation available time. The charge management server may also be configured to calculate usage fees of the reservation available time using the sum of reference usage fees and variable usage fees. The reference usage fees may be an imposed amount of money irrespective of a demand of the charging station and, in some exemplary embodiments, may be a predetermined fixed value or may be changed by a manager. For example, the reference usage fees may also be changed according to inflation or increase/decrease of oil price.

The variable usage fees may also be determined according to supply and demand. The charge management server may impose variable usage fees on a time point when a charging station has a high demand and is overcrowded. In some exemplary embodiments, the variable usage fees may be imposed when the number of charging reservation requests with respect to the first charger disposed in the first charging station for a predetermined time period from another vehicle except for the first vehicle that transmits the information request is counted and is greater than a predetermined value. The variable usage fees may be changed to correspond to the number of charging reservation requests with respect to the first charger.

For example, when the number of charging reservation requests from another vehicle to 07:00 from 06:00 is equal to or greater than six, the variable usage fees may be imposed to calculate real-time usage fees. When reservation request time included in the charging reservation request is in a predetermined time zone (e.g., time period or length), the charge management server may be configured to apply a predetermined ratio to calculate the variable usage fees. For example, when the reservation request time of the first vehicle is within a time zone of 05:00 to 08:00, which is set as a rush hour zone, the charge management server may be configured to apply 1.2 times to predetermined variable usage fees to change the variable usage fees. In other words, different times during the day may require higher usage fees based on the number of reservation requests typically received during such a time.

In some exemplary embodiments, when the reservation request time included in the charging reservation request of the first vehicle is within a time period between reservation charging time included in the charging reservation request of the second vehicle with respect to the first charger and reservation charging time included in the charging reservation request of a vehicle with respect to the first charger, the charge management server may be configured to apply a predetermined ratio to calculate the variable usage fees. In other words, usage fees may be discounted in a predetermined ratio with respect to spare time between reservation times of other vehicles to calculate the variable usage fees. The predetermined ratio applied to the spare time may be less than 1 and, in some exemplary embodiments, may have a negative value.

For example, when the second vehicle is set with second reservation charging time to 02:00 from 11:30 and the third vehicle is set with third reservation charging time to 05:00 from 02:30, if the first vehicle makes a reservation with 30 minutes between the second reservation charging time and the third reservation charging time, the charge management server may be configured to apply 0.8 times to the predetermined variable usage fees to change the variable usage fees.

In some exemplary embodiments, when a predetermined ratio is −0.5, the variable usage fees may have a negative value and, as a result, real-time usage fees determined using the sum with the reference usage fees may be determined to be less than the reference usage fees. The variable usage fees may be determined differently based on a time period between start time of the reservation request time included in the charging reservation request received from a vehicle and a time point of receiving the charging reservation request.

According to an exemplary embodiment of the present invention, variable usage fees when the time period between the start time and the time point of receiving the charging reservation request is greater than a particular time period may be determined to be less than variable usage fees when the time period between the start time and the time point of receiving the charging reservation request is less than the particular time period. For example, variable usage fees imposed when the first vehicle generates a request for reservation at 7 am to set reservation charging time to 02:00 from 11:00, which is four hours after the reservation is made, may be less than when reservation is generated at 10:00 and reservation charging time is set to 02:00 from 11:00, which is one hour after the reservation is made.

The variable usage fees may be determined to be further discounted the earlier a reservation request is made, thereby influencing a driver to request a charging reservation as early as possible. Accordingly, charging reservation may be created earlier and charging operations may be rapidly circulated.

Furthermore, chargers may have different charging methods and, in this regard, the charge management server may be configured to calculate variable usage fees according to the charging methods of the particular charger. The charging methods may include low-speed charging and high-speed charging. The first charger may use a low-speed charging method and the second charger may use a high-speed charging method. In general, variable usage fees of a charger using high-speed charging may be high and, in the case of high-speed charging, 1.5 times may be applied to predetermined variable usage fees to change the variable usage fees. For example, when 200 won/kWh is set for low-speed charging, 300 won/kWh may be set to high-speed charging.

The variable usage fees may also be determined based on a charging degree included in the charging reservation request and, in this regard, the charge management server may be configured to differentiate between complete charging and partial charging based on the charging degree to calculate the variable usage fees. A lower predetermined ratio may be applied to usage fees of partial charging than usage fees of low-speed charging to reduce variable usage fees, thereby enhancing charger utilization efficiency with respect to spare time.

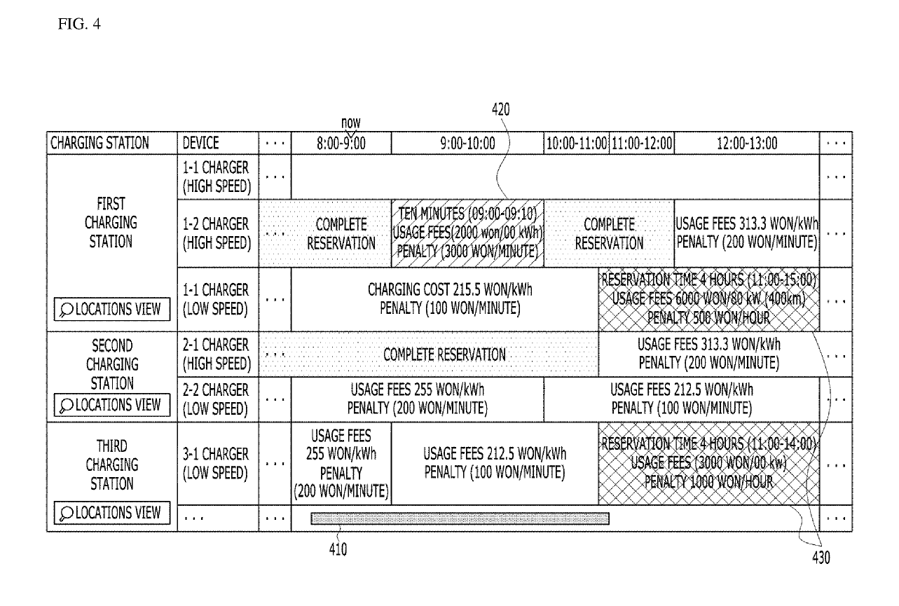

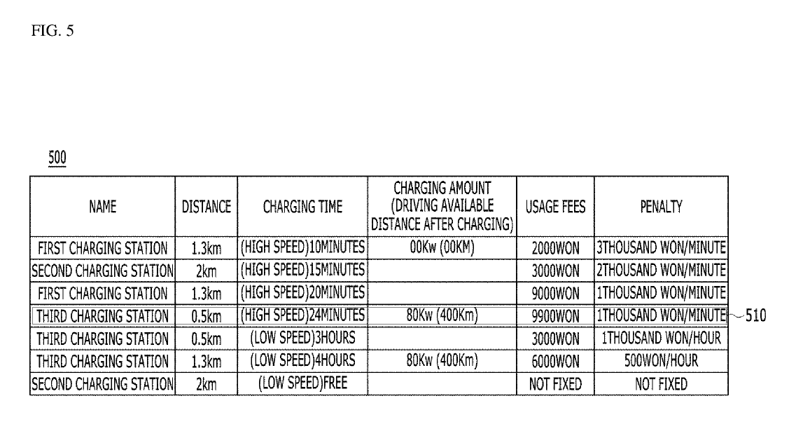

The charge management server may be configured to transmit information to the first vehicle regarding reservation available time at the first charger as a search result and information regarding usage fees of the reservation available time as a calculation result. The first vehicle may provide the received information to a driver through an output device of an audio video navigation (AVN) system and a detailed embodiment thereof is described in detail with reference to FIGS. 4 and 5.

The driver may input reservation setting information through an input interface of the vehicle and a telematics module of the first vehicle may be configured to transmit the charging reservation request including the reservation setting information to the charge management server. In response to receiving the charging reservation request from the first vehicle, the charge management server may be configured to set a reservation with the first charger via the first charging station server.

Further, the charge management server may be configured to transmit information regarding a reservation setting completion to the first vehicle. When charging of the first charger is completed, the charge management server may be configured to calculate a penalty and transmit and receive information related to payment to and from the first vehicle.

The penalty may be defined as an amount of money to be paid based on a time period (hereinafter referred to as “non-retrieval time”) to vehicle retrieval from charge termination when a driver does not retrieve the vehicle within a predetermined time period after the first charger terminates charging. For example, the penalty may be set to 100 won/minute. The penalty may be set differently for each time zone.

Additionally, the penalty may be differently imposed based on the number of reservations after a time point when the first vehicle is completely charged. For example, when the number of reservations is 3, the penalty may be changed to 500 won/minute from 100 won/minute. Alternatively, an amount of money calculated as 100 won/minute and usage fees of a reservation after a time point of charge completion may be summed to calculate the penalty.

The charge management server may be configured to calculate a final fee including the usage fees and the penalty and transmit information regarding the final fee to the first vehicle or a portable terminal that is previously paired with the first vehicle. Then, the charge management server may be configured to receive information regarding payment from the first vehicle or the portable terminal that is previously paired with the first vehicle.

FIG. 4 shows reservation information in the form of a time table output from a vehicle according to an exemplary embodiment of the present invention. FIG. 5 shows reservation information in the form of a list output from a vehicle according to an exemplary embodiment of the present invention. FIGS. 4 and 5 illustrate an output image of information received from the charge management server, provided to a driver via an output device of an AVN system of a vehicle, and are described together below. In some exemplary embodiments, the output device (e.g., display) of the AVN system mounted within the vehicle may be a touchscreen configured to receive input from a driver via touch. The vehicle may include an input unit configured to receive a reservation request for charging from the driver but, in some exemplary embodiments, the vehicle may be configured to output and receive information through the touchscreen.

A timetable 400 of FIG. 4 may include charging stations retrieved by the charge management server and reservations set with chargers disposed in the respective charging stations. A driver may receive information regarding a reservation completion and reservation available time based on time for each charger through the timetable 400. A bar 410 (e.g., a scroll bar on the interface or screen/display) that scrolls in right and left directions to monitor reservations of other time zones may be included in the timetable 400.

The timetable 400 may output a highlight 430 (e.g., or other indicating means) at a specific reservation time and the time of outputting the highlight 430 may be spare time to reservation completion and may be set with relatively low cost. The timetable 400 may indicate present time and indicate the highlight 430 on a cell that corresponds to a reservation available time zone based on estimated time of arrival to a charging station.

A list 500 of FIG. 5 may include a charging station list illustrating an available charger. The list 500 may include a charging station list of charging stations positioned within a predetermined distance, a charging station list of charging stations positioned within a driving available distance, or a charging station list of available charging stations to the estimated time of arrival. A driver may select 510 any one of charging stations from the list 500.

The aforementioned methods according to exemplary embodiments of the present invention may be implemented as a computer-readable program stored in a non-transitory computer-readable recording medium. Examples of the computer-readable recording medium include a ROM, a RAM, a CD-ROM, a magnetic tape, a floppy disk, an optical data storage device and the like, and implementation as carrier waves (e.g., transmission over the Internet).

The non-transitory computer readable recording medium can also be distributed over network coupled computer systems so that the computer readable code is stored and executed in a distributed fashion. Also, functional programs, code, and code segments for accomplishing the aforementioned method may be easily construed by programmers skilled in the art to which the present invention pertains.

A charge management server and a method of controlling the same according to the present invention may have the following effects.

First, the present invention may change charging station usage fees according to reservations to distribute charging reservations.

Second, the present invention may impose different usage fees to charging devices disposed in a charging station to enhance utilization efficiency of the charging station.

Third, the present invention may change charging station usage fees for respective specific time zones to distribute charging reservations and to reduce standby time of a user.

It will be appreciated by persons skilled in the art that that the effects that could be achieved with the present invention are not limited to what has been particularly described hereinabove and other advantages of the present invention will be more clearly understood from the above detailed description taken in conjunction with the accompanying drawings.

It will be apparent to those skilled in the art that various modifications and variations may be made in the present invention without departing from the spirit or scope of the invention. Thus, it is intended that the present invention cover the modifications and variations of this invention provided they come within the scope of the appended claims and their equivalents.

What is claimed is:

1. A method of controlling a charge management server, comprising:
receiving, by a server, a reservation time and reference usage fees of a first charger disposed in a first charging station from a first charging station server;
transmitting, by the server, the reservation time and real-time usage fees to a first vehicle that generates a request for charging station information; and
in response to receiving a charging reservation request with respect to the first charger from the first vehicle, transmitting, by the server, reservation information to the first vehicle,
wherein the real-time usage fees are determined as the sum of the reference usage fees and variable usage fees.

2. The method of claim 1, further comprising:
in response to receiving a payment request from the first vehicle, matching, by the server, cost including the real-time usage fees with the first vehicle.

3. The method of claim 1, wherein the variable usage fees are determined based on a number of charging reservation requests with respect to chargers disposed in the first charging station from at least one other vehicle except for the first vehicle for a predetermined time period.

4. The method of claim 1, wherein when reservation request time included in the charging reservation request is in a predetermined time zone, a predetermined ratio is applied to determine the variable usage fees.

5. The method of claim 1, wherein the variable usage fees are determined according to a charging method included in the charging reservation request and the charging method includes low-speed charging and high-speed charging.

6. The method of claim 1, wherein the variable usage fees are determined based on a charging degree included in the charging reservation request and the charging degree includes complete charging and partial charging.

7. The method of claim 1, wherein when the reservation request time included in the charging reservation request is in a time period between reservation charging time in a charging reservation request of a second vehicle with respect to the first charger and reservation charging time in a charging reservation request of a third vehicle with respect to the first charger, a predetermined ratio is applied to determine the variable usage fees.

8. The method of claim 1, wherein when the reservation request time included in the charging reservation request is in a time period between reservation charging time in a charging reservation request of a second vehicle with respect to the first charger and reservation charging time in a charging reservation request of a third vehicle with respect to the first charger, the variable usage fees are determined as a negative value.

9. The method of claim 2, further comprising:
matching, by the server, a final cost determined as the sum of the cost and a penalty with the first vehicle,
wherein the penalty is determined according to a non-retrieval time to vehicle retrieval from charge termination.

10. The method of claim 1, wherein the transmitting of the reservation time and the real-time usage fees to the first vehicle includes:
determining, by the server, whether the first charging station is positioned within a predetermined distance from the first vehicle or whether the first charging station is positioned within a driving available distance of the first vehicle.

11. The method of claim 1, wherein the transmitting of the reservation information includes:
transmitting, by the server, the reservation information to a second vehicle that currently performs charging through the first charger at a time point when a charging reservation request with respect to the first charger is received from the first vehicle.

12. The method of claim 1, wherein the variable usage fees are determined by applying a predetermined ratio in consideration of a time period between start time of reservation request time included in the charging reservation request and a time point of receiving the charging reservation request.

13. The method of claim 12, wherein variable usage fees when the time period between the start time and the time point of receiving the charging reservation request is greater than a particular time period are determined to be less than variable usage fees when the time period between the start time and the time point of receiving the charging reservation request is less than the particular time period.

14. A charge management server, comprising:
a communication unit configured to receive a reservation time and reference usage fees of a first charger disposed in a first charging station from a first charging station server and to receive a charging station information request from a first vehicle; and
a controller configured to calculate real-time usage fees determined as the sum of the reference usage fees and variable usage fees,
wherein the communication unit is configured to transmit the reservation time and real-time usage fees to a first vehicle that generates a request for charging station information and, in response receiving a charging reservation request with respect to the first charger from the first vehicle, the communication unit is configured to transmit reservation information to the first vehicle.

15. The charge management server of claim 14, wherein in response to receiving a payment request from the first vehicle, the controller is configured to match cost including the real-time usage fees with the first vehicle.

16. The charge management server of claim 14, wherein the controller is configured to determine the variable usage fees based on a number of charging reservation requests with respect to chargers disposed in the first charging station from at least one other vehicle except for the first vehicle for a predetermined time period.

17. The charge management server of claim 14, wherein when reservation request time included in the charging reservation request is in a predetermined time zone, the controller is configured to apply a predetermined ratio to determine the variable usage fees.

18. The charge management server of claim 14, wherein the controller is configured to determine the variable usage fees according to a charging method included in the charging reservation request and the charging method includes low-speed charging and high-speed charging.

19. The charge management server of claim 14, wherein the controller is configured to determine the variable usage fees based on a charging degree included in the charging reservation request and the charging degree includes complete charging and partial charging.

20. The charge management server of claim 14, wherein when the reservation request time included in the charging reservation request is in a time period between reservation charging time in a charging reservation request of a second vehicle with respect to the first charger and reservation charging time in a charging reservation request of a third vehicle with respect to the first charger, the controller is configured to apply a predetermined ratio to determine the variable usage fees.

21. The charge management server of claim 14, wherein the predetermined ratio applied to the variable usage fees is less than 1.

22. The charge management server of claim 14, wherein when the reservation request time included in the charging reservation request is in a time period between reservation charging time in a charging reservation request of a second vehicle with respect to the first charger and reservation charging time in a charging reservation request of a third vehicle with respect to the first charger, the controller is configured to determine the variable usage fees as a negative value.

23. The charge management server of claim 15, wherein the controller is configured to match final cost determined as the sum of the cost and penalty with the first vehicle and the penalty is determined according to a non-retrieval time to vehicle retrieval from charge termination.

24. The charge management server of claim 14, wherein the controller is configured to determine whether the first charging station is positioned within a predetermined distance from the first vehicle or whether the first charging station is positioned within a driving available distance of the first vehicle.

25. The charge management server of claim 14, wherein the communication unit is configured to transmit the reservation information to a second vehicle that currently performs charging through the first charger at a time point when a charging reservation request with respect to the first charger is received from the first vehicle.

26. The charge management server of claim 14, wherein the controller is configured to determine the variable usage fees by applying a predetermined ratio in consideration of a time period between start time of reservation request time included in the charging reservation request and a time point of receiving the charging reservation request.

27. The charge management server of claim 26, wherein variable usage fees when the time period between the start time and the time point of receiving the charging reservation request is greater than a particular time period are determined to be less than variable usage fees when the time period between the start time and the time point of receiving the charging reservation request is less than the particular time period.

28. A vehicle, comprising:
a communication unit configured to generate a request for charging station information to a charge management server and to receive a reservation time and real-time usage fees with respect to each of a plurality of chargers disposed in the charging station, from the charge management server;
a display configured to output the reservation time and the real-time usage fees with respect to each of the plurality of chargers; and
an input unit configured to input a reservation request for a first charger among the plurality of chargers,
wherein the real-time usage fees are determined as the sum of the reference usage fees and variable usage fees by the charge management server.

29. The vehicle of claim 28, wherein the input unit includes a user interface configured to receive information via a timetable having the reservation time and the real-time usage fees for each of the plurality of chargers displayed on the display.

30. The vehicle of claim 29, wherein the timetable includes a bar configured to scroll in right and left directions to monitor reservations of other time zones, outputs a highlight on a specific reservation time, and outputs a highlight on reservation available time based on an estimated time of arrival to the charging station.
